(19) United States
(12) Patent Application Publication
(10) Pub. No.: US 2004/0149531 A1
(43) Pub. Date: Aug. 5, 2004

(54) Linear mass damper mounting assembly

(76) Inventor: Markus Durre, Ann Arbor, MI (US)

Correspondence Address: FREUDENBERG-NOK GENERAL PARTNERSHIP, INTELLECTUAL PROPERTY DEPT., 47690 EAST ANCHOR COURT, PLYMOUTH, MI, 48170-2455, US

(21) Appl. No.: 10/658,582

(22) Filed: Sep. 9, 2003

Related U.S. Application Data
(60) Provisional application No. 60/409,628, filed on Sep. 10, 2002.

(51) Int. Cl. F16F 7/10

(52) U.S. Cl. 188/379

(57) ABSTRACT

A linear mass vibration damper mounting assembly for interconnecting a longitudinally-extending damper rod or other member with a second member, such as a vehicle frame, includes a central stud attached to the first longitudinally-extending damper rod, an open member at least partially surrounding the central stud, and a pair of elastomeric beam side structures inclined laterally and longitudinally to interconnect the stud with the open member. One of the beam side structures is in compression and the other of the beam side structures is in tension when vibrations are transmitted along the longitudinally-extending damper rod, thus effectively eliminating, or least substantially minimizing, transmission of such vibrations to the second member.

### BACKGROUND AND SUMMARY OF THE INVENTION

The invention relates generally to linear mass vibration dampers and, more specifically, such vibration dampers having a bracket assembly used to attached the damper to a structure, such as a vehicle, for example.

Dampers are commonly used in vehicles to reduce vibrations and noise levels. Such vibrations can induce booming, droning, spattering, and/or squeaking sounds that can be transmitted to a steering wheel, rear view mirror, interior trim, or other portions of the vehicle's interior or to the surroundings. Reduction of such unwanted vibrations and associated noise improves the handling and comfort of a vehicle.

According to the present invention, a vibration damper mounting assembly for interconnecting a longitudinally-extending first member (such as a damper rod or member, for example) with a second member (such as a vehicle frame, for example) includes a central stud member attached to the first longitudinally-extending member, an open generally hollow member at least partially surrounding the central stud member, and a pair of elastomeric beam side structures inclined generally laterally and longitudinally and interconnecting the stud member with the generally hollow member. One of the beam side structures is in compression and the other of the beam side structures is in tension when vibrations are transmitted along the longitudinally-extending first member. This effectively eliminates, or least substantially minimizes, the further transmission of such vibrations to the second member.

Optionally, the mounting assembly can have a portion or portions of the beam side structures extending generally axially or longitudinally along at least a portion of the central stud member. The mounting assembly can also include more than two of the beam side structures, extending in either opposite or the same generally lateral and longitudinal inclined directions. The said beam side structures can also extend in generally parallel directions. The elastomeric beam side structures can be composed of a rubber-containing material, a synthetic elastomer-containing material, or other suitable resilient materials known to those skilled in the art.

Typically, a pair of the vibration damper mounting assemblies are attached to each opposite end of the longitudinally-extending member (such as a damper rod, for example). The above-mentioned generally hollow member mat also include a bracket member adapted to be fixedly attached to the second member (such as the vehicle frame, for example).

Additional objects, advantages, and features of the present invention will become apparent from the following description and the appended claims, taken in conjunction with the accompanying drawings.

### BRIEF DESCRIPTION OF THE DRAWINGS

FIG. 1 schematically illustrates a vibrating structure and a mass damper with a single-degree of freedom system in a frequency domain.

FIG. 2 illustrates the relationship between amplitude and frequency, with and without a vibration damper attached to the structure of FIG. 1.

FIG. 3 schematically illustrates typical bending forces on a vehicle that can result in annoying or other undesirable vibrations being transmitted to the interior or surroundings of the vehicle.

FIG. 4 illustrates the installation of a typical conventional vibration damper on a vehicle.

FIG. 5 is a perspective view of the typical vibration damper of FIG. 4.

FIG. 6 is a partial cross-sectional view of the vibration damper of FIG. 5.

FIG. 7 is a partial cross-sectional view illustrating a tubular elastomeric boot structure of FIG. 6, but in a deflected or distorted condition.

FIG. 8 is a partial end view of a one end of a linear mass vibration damper according to the present invention.

FIG. 9 is a partial side view of the linear mass vibration damper of FIG. 8.

FIG. 10 is a partial cross-sectional view, taken generally along line 10-10 of FIG. 9, through the elastomeric beam.

FIG. 11 is a partial end view of a one end of another embodiment of a linear mass vibration damper according to the present invention.

FIG. 12 is a partial side view of the linear mass vibration damper of FIG. 11.

FIG. 13 is a partial cross-sectional view, taken generally along line 13-13 of FIG. 12, through the elastomeric beam.

FIGS. 14 through 17 schematically illustrate still other alternate elastomeric beam variations, according to the present invention.

### DETAILED DESCRIPTION OF THE PREFERRED EMBODIMENTS

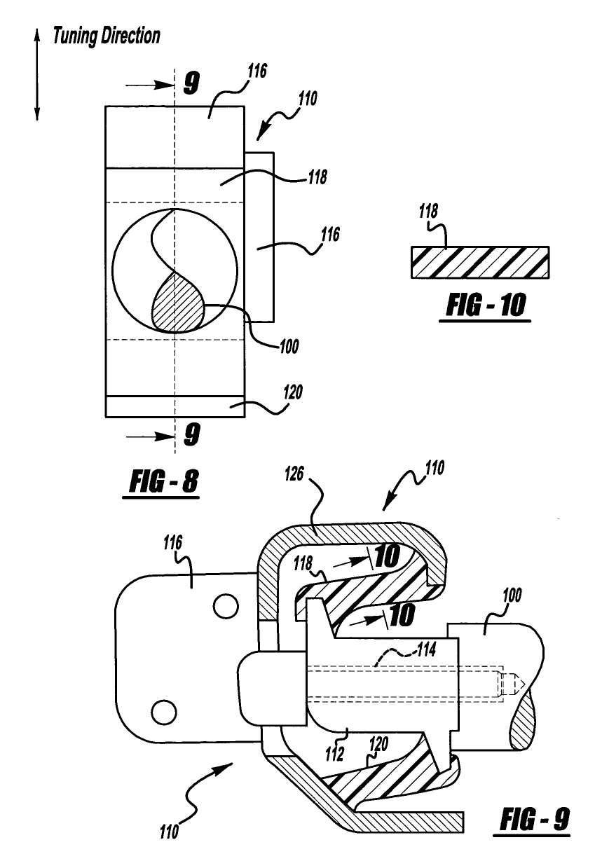

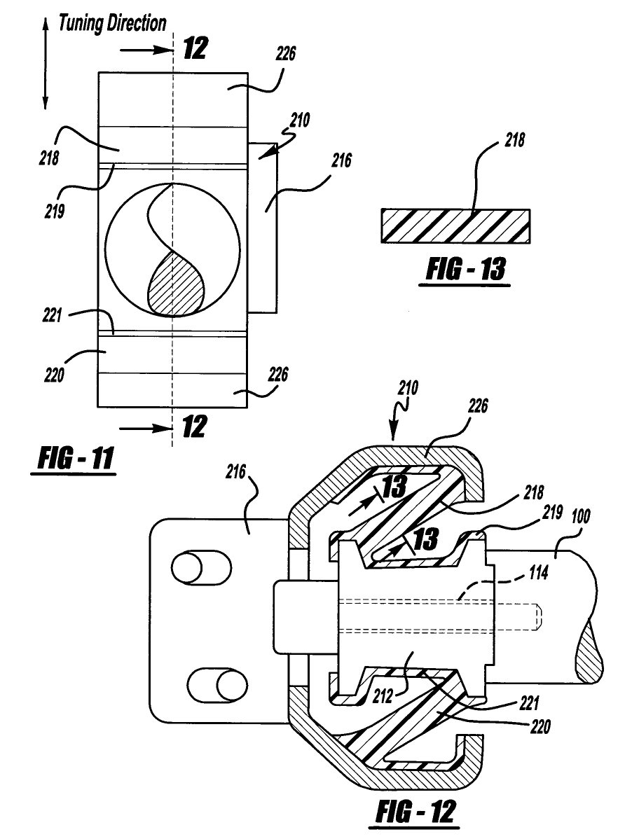

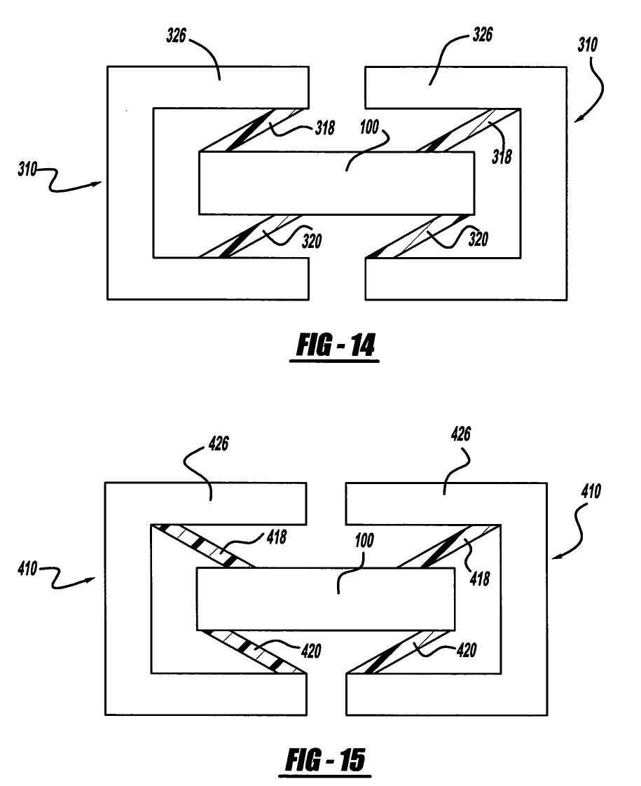

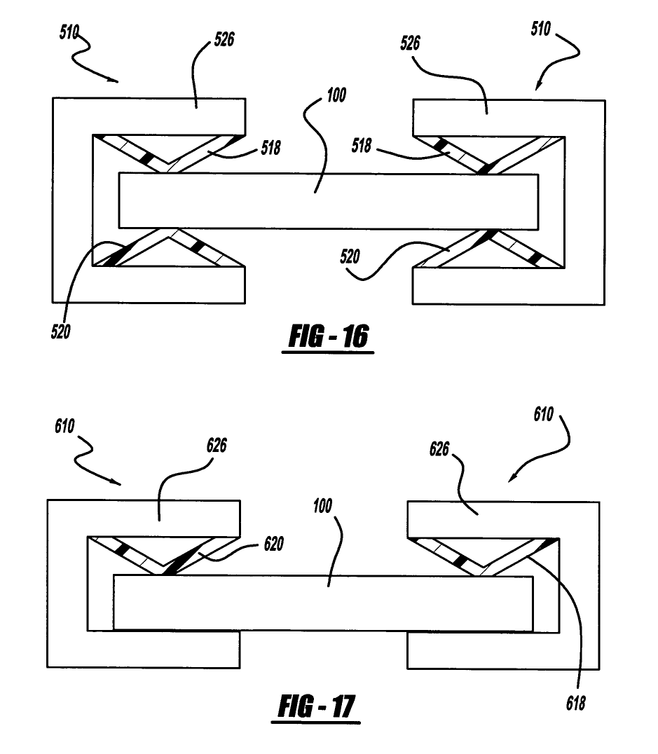

FIGS. 8 through 17 illustrate various preferred embodiments of a linear mass vibration damper according to the present invention. For purposes of example only, FIGS. 8 through 17 are primarily directed toward automotive applications for reducing unwanted noise and vibrations transmitted to the vehicle interior or its surroundings. It should be noted, however, as will become apparent to those skilled in the art from the following description and claims, the principles of the present invention are equally applicable to other devices where linear mass vibrations are to be reduced or substantially eliminated.

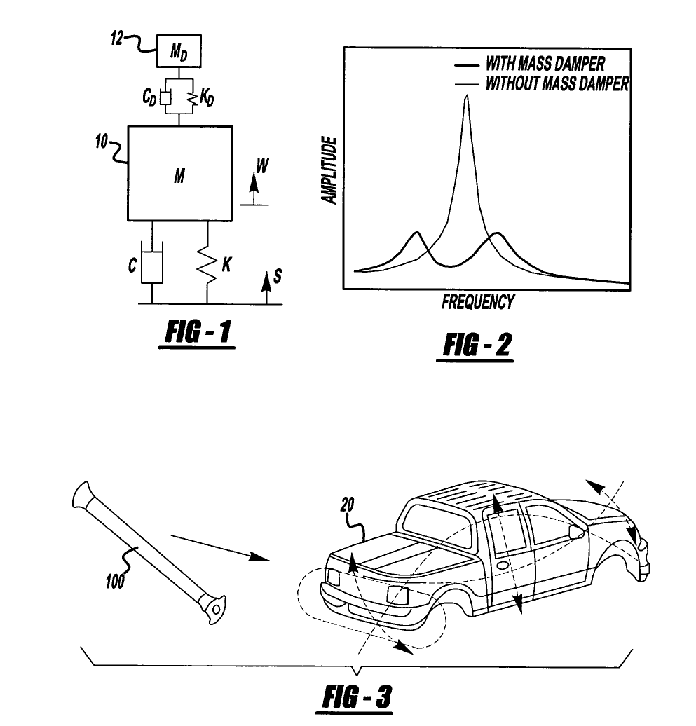

Referring first to FIGS. 1 through 7, wherein the background of the invention and prior art devices are depicted. A passive damper 12 is attached to a vibrating structure 10 in FIG. 1 and has a preselected resonance that compensates or balances out unwanted vibrations in the structure. FIG. 2 is a graph of the amplitude versus frequency, with and without the damper 12 attached to the structure 10.

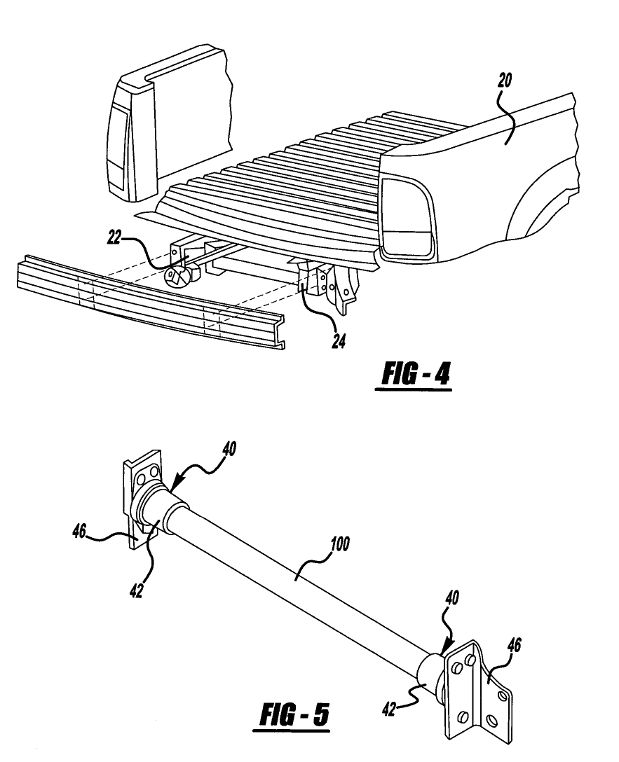

As illustrated in FIG. 3, a body 20 of a vehicle such as a pickup truck has several natural frequency modes, with the arrows representing a first bending frequency mode of the body 20. Road excitation in this mode can produce annoying or other unwanted vibrations being transmitted to the inside the passenger compartment of the body 20 or to its surroundings. A conventional linear mass damper 100 can be added to this system and can significantly reduce vibrations to the body 20, yielding results such as those shown in by the heavier curve in FIG. 2.

Such a conventional mass damper 100 is typically mounted between rearward ends of two, approximately parallel frame rails 22 and 24, which are mounted to an underside of the body 20, as illustrated in FIG. 4. One problem encountered when mounting the damper 100 at this location results from the significant tolerances in the dimension between, or the relative positions of, the frame rails 22 and 24 from one vehicle to the next.

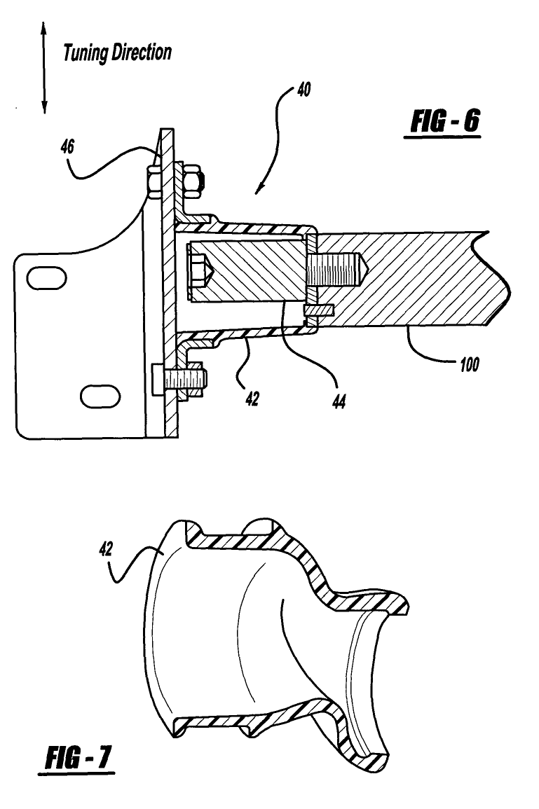

A linear mass vibration damper having a conventional mounting assembly 40 is indicated in FIGS. 5 through 7. The mounting assembly 40 includes a boot-like tubular elastomeric member 42 that surrounds a stud 44 (see FIG. 6). The stud 44 is provided between an end of the damper 100 and a bracket 46. The large dimensional and positional tolerances between the rails 22 and 24 can result in significant deflection and distortion of the assembled elastomeric member 42, as illustrated in FIG. 7. These distortions which cause variations in the length of the mounting assembly 40, can reduce the tuning accuracy of the damper 100, as well as the durability of the mounting assembly 40.

A first embodiment of a linear damper mounting assembly 110, according to the present invention, is illustrated in FIGS. 8 through 10. The mounting assembly 110 includes a linear mass damper rod member 100 connected to a hub or stud 112 by a fastener 114 (illustrated by dashed lines in FIG. 9).

Two elastomeric beams 118 and 120, or one generally hollow beam with two sides 118 and 120 (either referred to as beam sides herein) on opposite sides of the stud 112 interconnect the stud 112 to a bracket 116 by way of a generally hollow or surrounding member 126, with the bracket 116 in turn adapted to be fixedly attached to a vehicle frame member, for example. The beam sides 118 and 120 can be formed from any suitable elastic material, including rubber or synthetic materials. The elastomeric beam sides 118 and 120 are preferably relatively “soft” active elements arranged so that they are generally parallel to each other on opposite sides of the damper rod member 100.

When vibrations are transmitted along the length of the damper rod member 100 to the assembly 110 (which is attached to the vehicle), one of beam sides 118 and 120 is in tension, while the other beam is in compression. Thus when the mounting assembly 110 itself is in compression, one of the beam sides 118 and 120 is always in tension, and when mounting assembly 110 is in tension, one of the beam sides 118 and 120 is always in tension.

The relatively “soft” nature of the active elastomeric beam sides 118 and 120 results in the beam under compression being subject to a relatively indefinite amount of distortion and possibly even folding, Therefore, during an axial displacement, the beam under tension performs the bulk of the vibration isolation or reduction function. mostly the beam with tension works. This construction, according to the present invention, allows for proper alignment of the damper assembly at the vehicle's assembly line without the need for a costly or cumbersome jig or other fixture to facilitate the installation. Another advantage of the invention is that the assembly is sufficiently stiff to support the stud 112 in the axial or longitudinal direction and in one radial or lateral direction, while the vibration isolation in the tuning direction can be relatively soft to allow for proper vibration isolating effects.

FIGS. 11 through 13 illustrate a second preferred embodiment of a mounting assembly 210 according to the invention, wherein similar reference numerals to those of FIGS. 8 through 10 are used to indicate similar or corresponding elements of the mounting assembly 210 except that two-hundred prefixes are used in FIGS. 11 through 13.

In FIGS. 11 through 13, a side portions 219 and 221 of the elastomeric beam sides 218 and 220 extends axially outward along the stud 212 in order to further enhance their securement to the stud 212 where desirable or required in heavier-load applications.

Similarly, FIGS. 14 through 17 illustrate other alternative embodiments of the invention having mounting assemblies 310, 410, 510, and 610, respectively, with various examples of elastomeric beam (or beam side) configurations for achieving the desired vibration damping effects in other applications.

The foregoing discussion discloses and describes merely exemplary embodiments of the present invention for purposes of illustration only. One skilled in the art will readily recognize from such discussion, and from the accompanying drawings and claims, that various changes, modifications and variations can be made therein without departing from the spirit and scope of the invention as defined in the following claims.

What is claimed is:

1. A vibration damper mounting assembly for interconnecting a longitudinally-extending first member with a second member, said mounting assembly comprising:
a central stud member attached to the first longitudinally-extending member;
an open generally hollow member at least partially surrounding said central stud member; and
a pair of elastomeric beam side structures extending generally laterally and longitudinally and interconnecting said stud member with said generally hollow member, one of said beam side structures being in compression and the other of said beam side structures being in tension in response to a vibration transmitted along the longitudinally-extending first member in order to at least minimize the further transmission of such vibration to said second member.

2. A vibration damper mounting assembly according to claim 1, wherein the second member is a vehicle.

3. A vibration damper mounting assembly according to claim 1, wherein a portion of said beam side structures extends generally longitudinally along at least a portion of said central stud member.

4. A vibration damper mounting assembly according to claim 1, further comprising more than two of said beam side structures.

5. A vibration damper mounting assembly according to claim 1, wherein said beam side structures extend in opposite generally lateral and longitudinal directions.

6. A vibration damper mounting assembly according to claim 1, wherein said beam side structures extend in generally parallel generally lateral and longitudinal directions.

7. A vibration damper mounting assembly according to claim 1, wherein said elastomeric beam side structures are composed of a rubber-containing material.

8. A vibration damper mounting assembly according to claim 1, wherein said elastomeric beam side structures are composed of a synthetic elastomer-containing material.

9. A vibration damper mounting assembly according to claim 1, including a pair of said vibration damper mounting assemblies, one of said central stud members being attached to each opposite end of the first longitudinally-extending member.

10. A vibration damper mounting assembly according to claim 1, wherein said generally hollow member includes a bracket member fixed thereto, said bracket member being adapted to be fixedly attached to the second member.
